(19) United States
(12) Patent Application Publication
(10) Pub. No.: US 2012/0202412 A1
(43) Pub. Date: Aug. 9, 2012

(54) DEVICE AND METHOD FOR HANDLING EXCESS PAINT

(75) Inventor: Rainer Roeck, Aidlingen (DE)

(73) Assignee: DAIMLER AG, Stuttgart (DE)

(21) Appl. No.: 13/394,370

(22) PCT Filed: Oct. 2, 2010
(86) PCT No.: PCT/EP10/06027

§ 371 Date: Mar. 6, 2012

(30) Foreign Application Priority Data
Oct. 21, 2009 (DE) 10 2009 050 030.8

(51) Int. Cl. B05B 15/12

(52) U.S. Cl. 454/53

(57) ABSTRACT

The invention relates to a device (10) for handling excess paint (20) in a painting booth (12). The device (10) comprises a UV light source (28) by means of which a gas flow (22) containing the excess paint (20) can be exposed to ultraviolet light. The paint cured by means of the UV light is collected and separated from the gas flow (22) in a filter container (36) as paint powder (32). The invention further relates to a corresponding method for handling excess paint (20).

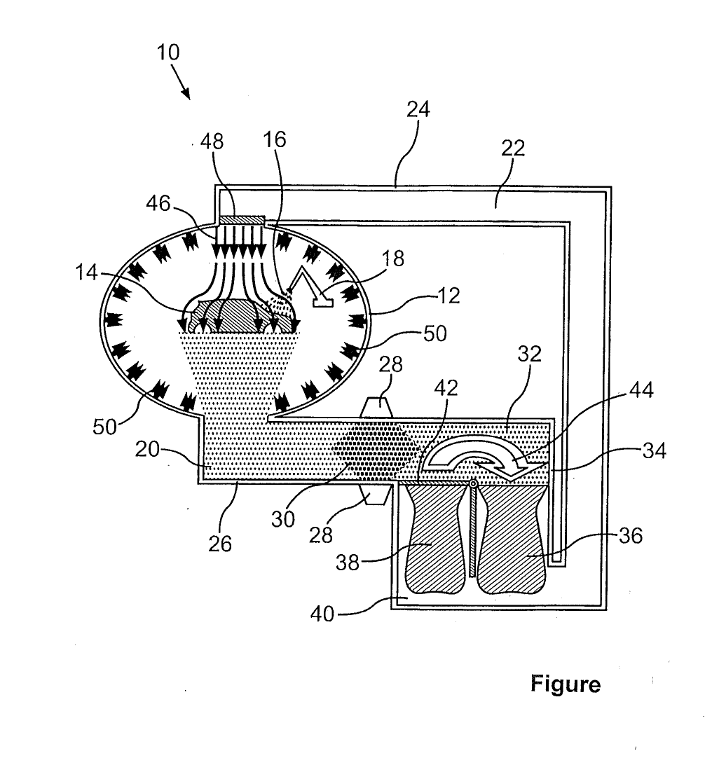

The invention relates to a device for handling excess paint arising in a painting unit. A separating unit for separating the excess paint from a media flow is hereby provided. The invention further relates to a method for handling excess paint in a painting unit.

DE 41 25 909 A1 describes a method for preparing paint sludge. Excess paint (so-called overspray) arising in a paint injection booth is hereby removed by means of water from the paint injection booth and rinsed into a stilling basin. A chemical is added to the water in the stilling basin which ensures the removal of the adhesive effect of the paint particles and leads to the agglomeration thereof to form a separable coagulated element. Powder-form expanded polyurethane is used as the chemical. By means of a separating unit the paint particles agglomerated through the polyurethane powder are separated from the stilling basin. The separated paint sludge is dried at a temperature of 50° C. to 200° C.

Furthermore DE 10 2005 013 711 A1 describes a device for separating excess wet paint, wherein as a separating unit surface filters which can be regenerated are arranged in an outgoing air flow of a painting unit. During this dry separation therefore no liquid is used to wash out the excess paint from the outgoing air flow. In order to ensure that the excess wet paint does not stick to the surface filters these are pre-coated with a powder-form material.

A disadvantage of these methods known from the prior art is regarded as the fact that additional substances are required in order to achieve an efficient separation of the excess paint from the media flow.

It is thus an object of the present invention to create a device of the type mentioned above and a corresponding method which facilitate a particularly simple separation of the excess paint from the media flow.

This object is achieved through a device having the features of claim 1 and through a method having the features of claim 7. Advantageous embodiments with useful further developments of the invention are indicated in the respective dependent claims.

The inventive device for handling excess paint arising in a painting unit comprises a separating unit for separating the excess paint from a media flow. Furthermore at least one light source is provided, by means of which the media flow containing the excess paint can be exposed to ultraviolet light. The exposure of the excess paint to ultraviolet light leads to curing of the paint particles when using paint which can be cured with UV light. Therefore, on account of the provision of the UV light source the excess paint can be separated from the media flow particularly simply as paint powder.

The removal of the adhesive capacity of the paint particles and the curing and coagulation thereof hereby advantageously take place in a single step, namely during radiation with the at least one light source. It is thereby particularly advantageous that the cured paint particles or paint droplets hereby remain in the media flow without having to be separated. The at least one light source is preferably designed to emit predominantly ultraviolet light, in particular exclusively ultraviolet light.

By means of the device a particularly pure excess paint can be separated from the media flow. Particularly if the UV-curable paint in the liquid state scarcely contains solvent a solid portion of almost 100%can be achieved in the separated paint powder. Such a very pure solid can fulfil particularly high quality requirements in relation to resource-saving and cost-saving utilisation. The device additionally facilitates a particularly simple process technology.

In an advantageous embodiment of the invention the media flow, which can be in particular a gas flow, preferably an inert gas flow, is circulated in a line system including the painting unit and/or the separating unit. As the excess paint cured through UV radiation to paint powder can be separated particularly simply from the media flow, a use of the media flow both as a carrier medium for removing the excess paint from the painting unit and for impacting the separating unit with the cured excess paint can be realised with particularly low resources. Inert gases which can be used are in particular nitrogen, argon, CO₂ or helium, whereby the latter can be retained particularly simply in the circuit and has particularly favourable thermal properties.

The separating unit preferably comprises at least one filter container, in particular which can be removed from the media flow. This allows a particularly efficient collection of the separated excess paint.

According to a further aspect of the invention in a method for handling excess paint arising in a painting unit, wherein the excess paint is separated from a media flow, a particularly simple separation of the excess paint is facilitated if the media flow containing the excess paint is exposed to ultraviolet light by means of at least one light source.

The excess paint cured by means of ultraviolet light can be incorporated into a moulding component. It is thereby particularly of interest to incorporate the cured excess paint into a moulding component, for example a plastic press or injection moulding component, which is used as a component for the originally painted object. According to an advantageous embodiment during painting of a motor vehicle the excess paint arising in this colour is used to colour plastic components for the vehicle painted in this corresponding colour. The plastic components are preferably thereby bodywork add-on components in the field of view.

As a supplement or an alternative to such a resource-sparing reuse of the excess paint a thermal utilisation of the excess paint or disposal can also be provided.

The advantages and preferred embodiments described for the inventive device also apply to the inventive method and vice versa.

The features and feature combinations mentioned above in the description and the features and feature combinations mentioned below in the description of the drawing and/or shown solely in the drawing can be used not only in the respectively indicated combination but instead also in other combinations or alone without going outside of the scope of the invention.

Further advantages, features and details of the invention follow from the claims, the following description of preferred embodiments and by reference to the drawing.

This shows schematically a device for handling excess paint arising during painting the bodywork of a motor vehicle.

A device 10 for handling excess paint comprises a painting booth 12, in which a bodywork 14 of a motor vehicle is coated with a paint 16 which can be cured through ultraviolet (UV) light.

Instead of the bodywork 14 shown by way of example it is also possible to provide components of a motor vehicle, for example panelling parts, axles, gearboxes and/or motors with the UV paint 16 in the painting booth 12. In order to apply the UV paint 16 to the bodywork 14 a painting robot 18 is provided. In alternative embodiments it is also possible to use a plurality of painting robots 18, particularly if the UV paint 16 is to be applied simultaneously from different directions to the component to be painted, in the present case the bodywork 14.

Furthermore in alternative embodiments the curing of the UV paint 16 can additionally take place in the painting booth 12 in that through exposure to ultraviolet light polymerisation is initiated which transforms the liquid UV paint 16 into a solid.

The UV paint 16 not sticking to the bodywork 14 leaves the painting booth 12 as excess paint 20 which is also described as overspray. As a carrier medium for removal of the excess paint 20 from the painting booth 12 in the present case an inert gas 22 is used which is circulated in a closed line system 24 containing the painting booth 12.

In a line section 26 of the line system 24 connecting downstream to the painting booth 12 two UV light sources 28 are provided. The UV light sources 28 ensure that the excess paint 20 transported with the inert gas 22 cures. Downstream of a curing region 30, in which the ultraviolet light generated by the UV light sources 28 completely penetrates the line section 26, the excess paint 20 is then in the form of paint powder 32.

By way of a separating unit for separating the paint powder 32 from the inert gas 22 in the present case a baffle wall 34 works together with a filter container 36 through which the inert gas 22 can flow. Upon separation of the paint powder 32 therefore—as set out by way of example in the present case—a centrifugal force separation can support the filtration by means of the filter container 36. Likewise a centrifugal force separator can be used instead of the filter container 36. The filter container 36 can—as shown by way of example in the present case—be removable from the media flow 22 or it can be designed as a fixed-position filter silo.

A second filter container 38 is arranged in a chamber 40 of the line system 24, through which there is no flow in the operating mode of the device 10 shown in the drawing. The chamber 40 is indeed closed by means of a valve 42. Instead of the valve 42 shown by way of example a slide or similar switching device can also be provided. By pivoting the valve 42 corresponding to a movement arrow 44 shown in the drawing it is ensured that the first filter container 36 is no longer impacted with the paint powder 32 but instead the second filter container 38. This arrangement of the filter containers 36, 38 allows an exchange of the loaded filter container 36 without having to interrupt the process.

A conveying unit not shown in further detail in the present case ensures that upon entry of the inert gas 22 into the painting booth 12 a laminar flow 46 of the inert gas 22 is achieved. As a supplement or alternative this can be achieved through a guiding unit 48 arranged in an inlet of the painting booth 12.

In the region of the painting booth 12 nozzles 50 prevent adhesion of the excess paint 20 to an inner wall of the painting booth 12. The nozzles 50 which are shown by way of example in the present case distributed over the inner wall of the painting booth 12 can additionally influence a flow direction of the inert gas 22 in the region of the painting booth 12 in such a way that the excess paint 20 is transported to the outlet of the painting booth 12.

### LIST OF REFERENCE NUMERALS

10 Device

12 Painting booth

14 Bodywork

16 Paint

18 Painting robot

20 Excess paint

22 Inert gas

24 Line system

26 Line section

28 UV light source

30 Curing region

32 Paint powder

34 Baffle wall

36 Filter container

38 Filter container

40 Chamber

42 Valve

44 Movement arrow

46 Flow

48 Guiding unit

50 Nozzle

1.-9. (canceled)

10. A device for handling excess paint (20) arising in a painting unit (12), having a separating unit (36, 38) for separating the excess paint (20) from a media flow (22), wherein the media flow (22) is a gas flow and the device (10) comprises at least one light source (28), by means of which the media flow (22) containing the excess paint (20) can be exposed to ultraviolet light, and the separating unit comprises at least one filter container (36, 38) which can be removed from the media flow (22).

11. The device according to claim 10, wherein the gas flow is circulated in a line system (24) including at least one of the painting unit (12) and the separating unit (36, 38).

12. The device according to claim 10, wherein the painting unit (12) comprises means (50) for preventing adhesion of the excess paint (20) to a wall of the painting unit (12).

13. The device according to claim 10, wherein the separating unit comprises at least one filter container (36, 38) which can be removed from the media flow (22).

14. The device according to claim 13, wherein a switching device (42) is provided, by means of which the excess paint (20) can optionally be fed to a first filter container (36) or a second filter container (38).

15. The device according to claim 10, wherein at least one of a conveying unit and a guiding unit (48) is provided, by means of which a laminar flow (46) of the media flow (22) can be achieved.

16. The device according to claim 10, wherein the means (50) for preventing adhesion of the excess paint (20) to a wall of the painting unit (12) comprises means for influencing a direction of the media flow (22).

17. A method for handling excess paint (20) arising in a painting unit (12), wherein said excess paint consists of a light or UV curable paint, comprising:
exposing the media flow (22), which is a gas flow, containing the excess paint (20) to ultraviolet light by means of at least one light source (28) to cure the excess paint, and
separating the excess paint (20) from a media flow (22).

18. The method according to claim 17, further comprising incorporating the excess paint (20) cured by means of ultraviolet light as paint powder (32) into a moulding component.

19. The method according to claim 18, wherein the moulding component is a plastic add-on component for a motor vehicle.
